(19) United States
(12) Patent Application Publication
(10) Pub. No.: US 2015/0142383 A1
(43) Pub. Date: May 21, 2015

(54) RADIATION DETECTOR DEVICE AND METHOD

(71) Applicant: Kromek Limited, Sedgefield, Durham (GB)

(72) Inventors: Ian Radley, Durham (GB); Craig Hamilton Duff, Harlepool (GB); Laura Joanne Harkness, Yarm (GB)

(73) Assignee: Kromek Limited, Sedgefield, Durham (GB)

(21) Appl. No.: 14/401,309

(22) PCT Filed: May 21, 2013
(86) PCT No.: PCT/GB2013/051315

§ 371 Date: Nov. 14, 2014

(30) Foreign Application Priority Data
May 22, 2012 (GB) 1209036.1

(51) Int. Cl. G01T 1/17; G01T 1/02

(52) U.S. Cl. CPC G01T 1/17; G01T 1/02; G01J 3/28
USPC 702/179

(57) ABSTRACT

A radiation detector device is described comprising a detection module, a processing module, and a display module, wherein the detection module includes a detector adapted to detect incident radiation in spectroscopically resolved manner in plural separate energy bands; the processing module is adapted to process the spectroscopically resolved data numerically and thereby to produce at least a first data item indicative of a measure of radiation incident at the detector and a second data item indicative of a statistical certainty applicable to the first data item; the display module is adapted to produce a display representative of both the first data item and the second data item. A radiation detection method, a kit of parts for implementing the same for example in combination with a suitable programmable device, and associated concepts, are also described.

The invention relates to a radiation detector device, a radiation detection method, a kit of parts for implementing the same for example in combination with a suitable programmable device, and associated concepts. The invention in particular relates to a radiation detector device and method which is especially suited for portable application, for use by a non-expert user, and adapted for use in conjunction with existing computer processing means, and in particular portable processors, such as may be found on laptop computers, tablet computers, cell-phone etc., on bespoke portable devices, on personal computers etc. The invention may relate to an apparatus and a method implemented by suitable combinations of hardware, firmware and software, to a kit of parts optionally including a portable device and computer readable instructions for the same, and to a method of processing and display of collected radiation data.

Many reasons can be appreciated why it might be desirable to provide a simple portable radiation detector which can be used easily in a range of locations, in particular for example by a non-expert user. Such a simple detector may be useful as a safety or security device, and provision of a large number of such detectors may be useful in providing a degree of environmental safety and security at a community as well as an individual level.

Portability of the detector device may be enhanced if a separate portable detection module is provided which detects data regarding incident radiation in a manner adapted for processing and display via a suitable processing unit, for example being a bespoke processing unit, or the processor on a suitable computer or the like.

Prior art portable radiation detectors are known. These typically comprise portable Geiger tubes, other simple radiation dose meters or the like. These typically measure the intensity of incident radiation on a crude count-rate model. The data is simple and absolute. For example, such simple detectors provide no spectroscopically resolved information about the incident radiation. The further information that could be obtained from such a more comprehensive spectroscopically resolved indication of incident radiation, for example to help identify the source, to indicate the nuclide etc., is not available. The extent to which the data could be manipulated statistically is limited. For example there is an advantage in using spectroscopically resolved intensity to calculate dose rate. As the dose is energy dependent, the actual dose can be more accurate as no assumptions about the average energy of the photons collected have to be made.

The invention is directed at the provision of a radiation detector device and method which mitigates at least some of the disadvantages of existing systems.

The invention is in particular directed at the provision of a radiation detector device and method which offers enhanced possibility for the manipulation of data, in particular to improve identification of the nature of the radiation and/or to improve the statistical analysis of the significance of the collected data, for example to give an indication of statistical certainty of any intensity reading.

The invention is in particular directed at the provision of a radiation detector device and method suited for portable operation in the field, for example by a non-expert user.

The invention is in particular directed at the provision of a radiation detector device and method implemented by a portable detector unit suited to use in conjunction with a central processor at a remote site.

Thus, according to the invention in a first most complete aspect, a radiation detector device comprises a detection module, a processing module, and a display module, wherein:

the detection module includes a detector adapted to detect incident radiation in spectroscopically resolved manner in plural separate energy bands;
the processing module is adapted to process the spectroscopically resolved data numerically and thereby to produce at least a first data item indicative of a measure of radiation incident at the detector and a second data item indicative of a statistical certainty applicable to the first data item;
the display module is adapted to produce a display representative of both the first data item and the second data item.

The detector is adapted to detect incident radiation in spectroscopically resolved manner in plural separate energy bands in the sense that it is adapted to differentiate incident radiation simultaneously into plural separate energy bands and preferably at least three such energy bands across the expected detection spectrum. For example, the detector exhibits a spectroscopically variable response across at least a part of the expected detection spectrum allowing such simultaneous differentiation of incident radiation into plural energy bands.

The data processing module is adapted to exploit this feature of the system so as to coprocess the resolved incident radiation dataset and thereby derive further information. In particular, it is a specific feature of the invention that the data processing module is adapted not only to produce a first data item indicative in some way of the intensity of radiation incident upon the detector but also to process the collected and spectroscopically resolved data regarding radiation incident at the detector numerically in order to perform a statistical analysis of the quality of the data which produced the first data item. The purpose of this analysis is to produce a quantified indication of the uncertainty in the first data item. A variety of statistical techniques will be readily available to the skilled person, and a number of possible examples are suggested below. The invention is not limited to a particular statistical technique, provided that the statistical technique employed makes a numerical analysis which exploits the spectroscopic resolution in the collected data that produced the first data item in order to generate as a second data item a quantified measurement of the uncertainty in the first data item.

This is a key feature characterising all aspects of the invention described herein in its intended use. The detector is adapted to detect incident radiation in spectroscopically resolved manner in plural separate energy bands. Use is made of the spectroscopically resolved data regarding incident radiation collected at the detector at least in that the data processing module is adapted to exploit this spectral resolution to obtain, via suitable numerical statistical analysis of the resolved incident radiation data, an improved quantification of the uncertainty in the incident radiation data so collected, and for example in any cumulative collected intensity data or cumulative collected intensity spectrum or dose rate spectrum.

The display module is adapted to produce a display representative of both the first data item and the second data item. The display module is therefore adapted to produce a display which includes a representation of the measurement of the radiation collected at the detector, and which further includes a specific numerically calculated quantification of the uncertainty in that measurement. The display module is therefore adapted to produce a display which includes a representation of a measure of the radiation intensity incident at the detector, and which further includes a specific numerically calculated quantification of the uncertainty in that measure.

A first data item may be any item related and for example functionally related to the incident radiation and for example incident radiation intensity at the detector. It is not necessarily a raw data measurement. More usually it may be a derived quantification based on incident radiation and for example incident radiation intensity at the detector, and is for example in a possible case a dose rate. A second data item may be any item numerically quantifying the uncertainty in that measure and for example dose rate. This combination of presentation of both intensity related data and uncertainty data is not offered by the prior art, and is made possible by the numerical analysis technique employed in accordance with the invention to exploit the additional information attributable to the spectroscopic resolution of the collected spectrum.

The key to the invention is therefore that the spectroscopic resolution in the collected radiation data gives a means by which the device is able to perform a statistical significance analysis of that data to give a quantitative measure of the incident radiation and in particular a quantitative measure related to the intensity of incident radiation and of the uncertainty in that quantitative measurement of the incident radiation and for example to give a quantitative measurement of both an intensity at the detector such as a cumulative collected intensity or cumulative collected intensity spectrum or dose rate and of the uncertainty in that cumulative intensity or dose rate.

The first data item may be any item related and for example functionally related to the incident intensity at the detector, whether presented as a cumulative dose measurement, a dose rate, a cumulative spectrum, or any other measurement derived in some way from radiation intensity at the detector. Where reference is made herein to such a data item for simplicity as an intensity measurement it should be understood in that context.

At its broadest, while the device of the invention inherently exploits the spectroscopic resolution of the collected incident radiation data to make an analysis of, and display, the uncertainty in the measurement of collected incident radiation date, the measurement and display of a measure representative of the collected intensity itself need not be spectroscopically resolved. It is nevertheless a feature of the detector of the invention that it would be possible also to resolve the intensity data spectroscopically, and to present the intensity data resolved spectroscopically across a plurality of energy bands, for example in such case with an uncertainty measurement being presented for the overall spectrum and/or for the data in each band. The data processing module and display module may for example be adapted to do this.

That is to say, the processing module may be adapted to process the spectroscopically resolved data numerically and thereby to produce at least a first set of data items indicative of a measure of radiation and for example a radiation intensity incident at the detector at a plurality of energy bands across at least a part of the detected spectrum, and the display module may be adapted to produce a display representative of the first set of data items differentiated across the plurality of energy bands. Thus, in this embodiment, the processing module generates and the display module displays a spectrum such as an intensity spectrum or dose rate spectrum derived from radiation incident at the detector. The plural first data items making up the first set of data items may be displayed for example simultaneously as an intensity spectrum or dose rate spectrum.

Such spectroscopically resolved collected incident radiation data information could for example be used, as presented or by further numerical analysis, to give indications concerning identification of a source nuclide, for example to identify a particular target nuclide, to enable comparison between natural and artificial sources, to identify a particular artificial source or the like.

Preferably, the data processing module is adapted to process the resolved incident radiation data set and obtain uncertainty information therefrom progressively as intensity data is collected at the detector, and the display is correspondingly adapted to display in representative manner both the first and the second data items as they change as data is progressively collected over time. That is to say, the data processing module produces, and the display module displays, a progressively variable incident radiation measure and a correspondingly changing uncertainty which change to reflect the more complete picture that is built up as data is progressively collected over time. Typically for example this will allow a user to monitor both an incident radiation reading and receive an indication of the degree of certainty which will increase as the volume of collected data increases in a typical case.

It can be seen that the calculated uncertainty may be used directly or indirectly as an indicator of progress of a data collection process. In particular completion of a data collection phase may be defined as being determined by the calculated uncertainty falling below a pre-determined threshold value. The calculated uncertainty may be used directly or indirectly as an indicator of progress towards or completion of the data collection phase so defined. For example as a part of or separately from any display of uncertainty information the processing module may be adapted to determine and the display module to display data indicating progress of data collection as a function of calculated uncertainty. For example this may be a completion indicator which indicates the completion of a data collection phase as determined by the calculated uncertainty falling below a pre-determined threshold value. This may be a progress to completion indicator which indicates the progress of a data collection phase as determined by the calculated uncertainty falling towards a pre-determined threshold value as data is progressively collected over time.

The invention lies in particular in the use of spectroscopically resolved collected intensity data information as the basis not only for determination of a first data item being an incident radiation measure such as an intensity measure and for example an intensity spectrum or dose rate spectrum but also of a numerical calculation of a second data item being the statistical uncertainty in that determined intensity measurement, and in the display of this statistical uncertainty together with the display of the determined incident radiation measure.

The display of these two items together comprises the presentation on suitable display means on the display module of a representative visual, audible or other quantification of each data item simultaneously or closely successively. A representative quantification of each data item may be presented in the form of discrete representations displayed simultaneously via different sensory modalities (eg visual and auditory), in the form of discrete visual representations displayed simultaneously and spaced apart, or in the form of discrete representations successively, or may be presented in the form of a single representation providing a simultaneous quantification of each data item. In a preferred case the first and second data items are displayed simultaneously. In a particular preferred case a representative visual quantification of each data item is made simultaneously in that a single visual representation is displayed providing a simultaneous quantification of each data item.

In such a case where a single visual representation is displayed providing a simultaneous quantification of each data item spatial resolution may be used to provide further information. For example spectral resolution may be given spatially with the data resolved across plural energy bands represented spatially by dividing the display into plural areas mapped to the plural energy bands, and a first and second data item for each energy band displayed simultaneously in a single such area.

A combined visual display may be adapted to use various modes to provide a representative quantification of each data item, for example including colour, brightness, saturation, pixellation, alphanumeric presentation and the like. In the preferred case where a single visual representation is displayed providing a simultaneous quantification of each data item at least one different such mode is used to present each data item.

The radiation to be detected is for example high-energy radiation such as ionizing radiation, for example high energy electromagnetic radiation such as x-rays and/or gamma rays, or subatomic particle radiation, and the detector is adapted correspondingly to detect radiation in this spectrum.

The detector preferably exhibits a spectroscopically variable response across at least a part of this spectrum allowing spectroscopic information to be retrieved and allowing incident radiation information to be detected simultaneously at a plurality of differentiated energy bands. Preferably incident radiation data is resolved spectroscopically between at least three energy bands simultaneously.

A suitable detector for implementation of the invention comprises one or more detector elements of a semiconductor material adapted for high energy physics applications, such as a material able to act as a detector for high energy radiation, and for example high energy electromagnetic radiation such as x-rays or gamma rays, or subatomic particle radiation. The resultant detector element comprises at least one layer of such material and is thus a device adapted for high energy physics applications, and for example a detector for high energy radiation such as x-rays or gamma rays, or subatomic particle radiation.

In accordance with the invention, collected data is resolved spectroscopically across at least two and preferably at least three energy bands within the spectrum of the source. The semiconductor material of at least one of the detector elements is preferably a material adapted to exhibit a spectroscopically variable response across at least a substantial part of the intended radiation spectrum in use. In particular a semiconductor material is used that exhibits inherently as a direct material property a direct variable electrical and for example photoelectric response to different parts of the radiation spectrum in use.

In a preferred embodiment the semiconductor material is formed as a bulk crystal, and for example as a bulk single crystal (where bulk crystal in this context indicates a thickness of at least 500 μm, and preferably of at least 1 mm).

In a preferred embodiment the semiconductor material may be selected from Group II-VI semiconductors and in particular may be selected from cadmium telluride, cadmium zinc telluride (CZT), cadmium manganese telluride (CMT), and alloys thereof, and for example, save for incidental impurities, consists essentially of crystalline Cd_{1-(a+b)}MnₐZn_{b}Te where a+b<1 and a and/or b may be zero. A detector may also have other detector elements of other materials for additional functionality.

The detector of the first aspect of the invention conveniently comprises such detector element(s) compactly associated together in a portable manner, for example within a housing, for example to constitute a portable detector unit, with such suitable further components and control electronics, either within the housing or elsewhere, as may be necessary to enable the collection and downloading to a suitable processing module of spectroscopically resolved data regarding incident radiation intensity.

The detection module includes such a detector, and the complete detector device implementing the most complete first aspect of the invention combines this detection module with a data processing module and display module as above described. Subject to this the precise means by which an further function of the detection module and the precise means by which the data processing module and display module are implemented in accordance with the invention is not limited.

In particular, the detection module may otherwise comprise, and the processing module and display module may comprise, any suitable combination of additional hardware, firmware and software, whether incorporated onto, implemented by, or otherwise provided on a bespoke device integral with or separate from the detector, or on a further device including a central processor with which the detector is provided for use with and is functionally connected to in use.

The device of the first aspect of the invention may comprise an integral device combining the functions of the detection module, processing module and display module or may be formed of a plurality of discrete units. In the latter case, one or more bespoke discrete units may be adapted for use with one or more known devices, such as one or more known programmable devices including a central processor, such that in combination the discrete unit(s) and the known device(s) for example in the case of known programmable device(s) provided with suitable device readable instructions, constitute in combination a detection module and a data processing module and a display module as above described.

In a particularly preferred implementation of the principles of the invention, a detector device in accordance with the first aspect of the invention is implemented in use in combination by:

a portable detector unit comprising at least the detector and for example the detection module as above described and including a data communication means to effect a data communication to an additional programmable device including a central processor, and
suitable machine readable instructions to be implemented by the combination of the portable device and the additional device when connected in data connection so that the combination serves as a detection module, data processing module and a display module as above described. In particular the combination and in particular the additional programmable device when programmed with the suitable machine readable instructions serves as a data processing module and a display module as above described and/or performs the data processing and display steps as herein described.

The portable detector unit conveniently comprises suitable detector element(s) as above described compactly associated together in a portable manner, for example within a housing, with such suitable further components and control electronics, either within the housing or elsewhere, as may be necessary to enable the collection and downloading to a suitable processing module of spectroscopically resolved data regarding incident radiation intensity, and for example includes a multi-channel analyser to analyse the resolved data and for example includes a data connection means to connect the portable unit to a suitable processing module in manner such as to enable the transfer of such resolved data.

Thus, in the preferred case the detector device in accordance with the first aspect of the invention is implemented in use by a portable detector unit comprising at least a detector as above described in data connection with an additional programmable device including a central processor and carrying suitable program instructions to cause it to function as a data processing module and a display module as above described and/or to perform the data processing and display steps as herein described.

The suitable additional programmable device might for example be a portable computing device with a visual or other display capability such as a laptop, tablet, cell-phone etc., or a bespoke portable device into which the portable detector unit may be connected for data communication and transfer.

By implementation of suitable program instructions on the processor of the additional programmable device, the processor may serve as the data processing module, and the display thereon may serve as the display module. Thus, the portable detector unit in combination with the said program instructions comprise a conversion for such an additional programmable device, which can convert the same into a radiation detector in accordance with the first aspect of the invention.

Thus, without parting from the scope of the first aspect of the invention at its broadest, the processing module may be composed in whole or in part as a discrete device or part thereof, and/or in whole or in part as suitable program instructions for implementing an equivalent function in use with an additional programmable device.

Similarly, the display means may be provided in whole or in part in a discrete device and/or in whole or in part in the form of suitable program instructions for implementing an equivalent function in use with an additional programmable device.

The invention at first aspect is thus in this embodiment implemented in full when a suitable discrete portable unit is engaged in data connection with a suitable programmable device.

It follows that in accordance with the invention in a further aspect, there is provided a kit of parts adapted for use with a suitable programmable device so as to convert the programmable device into a radiation detector device in accordance with the first aspect in the invention.

Such a kit of parts comprises for example a portable detector unit comprising at least the detector and for example the detection module as above described and including a data communication means to effect a data communication to an additional programmable device including a central processor, and

suitable machine readable instructions to be implemented by the combination of the portable detector unit and the additional programmable device when connected in data connection so that the combination when so connected and programmed constitutes a detection module, data processing module and a display module as above described.

The machine readable instructions may comprise program instructions, whether on a suitable data carrier on the portable detector unit or otherwise or made accessible via the portable detector unit for example via remote download, to implement in a central processor of the programmable device when the portable detector unit is connected in data connection to the programmable device a series of process steps which will cause the combination of portable unit and programmable device to comprise a data processing module and a display module as above described.

The invention envisages any suitable data connection being exploited between the portable detector unit and the programmable device, for example wired or wireless, and for example including optical and audio connections etc., such as are already provided in accordance with routine standards on cell-phones, laptops, tablets and the like. Preferably it exploits an existing and standard connection already provided on such a programmable device. This need not be a primary digital data download connection. It might be desirable to keep such a primary digital data connections free. To that end, in a possible embodiment, the portable detector unit is adapted to effect a data connection for download of data to a programmable device via a secondary data link such as via the audio jack.

As will be appreciated by analogy, the invention additionally comprises methods for the implementation of some or all of the foregoing principles, including a method for the detection of radiation which encompasses a method of processing for display and displaying detected radiation, a method of use of a device as above described, and a method of adapting an existing programmable device including a central processor to serve as a device as above described.

In particular in a further aspect the invention comprises the use of a device as above described to collect incident radiation data in spectroscopically resolved manner resolved into plural separate energy bands, and to calculate and display therefrom at least a first data item indicative of a measure of radiation and for example radiation intensity incident at the detector and a second data item indicative of a statistical certainty applicable to the first data item.

In particular in a further aspect of the method the invention comprises a method for the processing for display and preferably further for the display of detected radiation data which has been spectroscopically into plural separate energy bands, and comprises the steps of:

processing the spectroscopically resolved data numerically to produce at least a first data item indicative of a measure of radiation and for example radiation intensity incident at the detector and a second data item indicative of a statistical certainty applicable to the first data item;
optionally further presenting a display representative of both the first data item and the second data item.

In particular in a further more complete aspect of the method the invention comprises a method for the detection of radiation comprising, prior to the performance of the foregoing steps, a step of:

collecting incident radiation at a detector in such manner that the incident radiation is spectroscopically resolved into plural separate energy bands, for example by bringing a suitable radiation detector device, such as a detector device as above described, into an environment to be tested and collecting incident radiation at the detector for a suitable time period.

Thus, the principles of the method aspects of the invention parallel those of the device aspects, and preferred features will be understood by analogy, as including but not being limited to those considered below.

In particular the method makes use of incident radiation which has been collected in spectroscopically resolved manner, resolved into plural separate energy bands in the sense that it is adapted to differentiate incident radiation simultaneously into plural separate energy bands and preferably at least three such energy bands across the expected detection spectrum.

The spectral resolution is exploited by coprocessing the resolved incident radiation dataset across these plural energy bins to derive further information. In particular not only is a first data item produced indicative in some way of the intensity of radiation but the spectroscopically resolved data is processed numerically in order to perform a statistical analysis of the quality of the data which produced the first data item relating to radiation intensity and thus a quantified indication of the uncertainty in the first data item.

Use is thus made of the spectroscopically resolved incident radiation data at least to obtain, via suitable numerical statistical analysis of the resolved intensity data, an improved quantification of the uncertainty in the incident radiation data so collected, and for example in any cumulative collected intensity data or cumulative collected intensity spectrum or dose rate spectrum.

In a further display step a display may be presented which includes a representation of the measured incident radiation data and for example in some way of the intensity of the collected radiation, and which further includes a specific numerically calculated quantification of the uncertainty in that measure of incident radiation. This combination of presentation of both incident radiation data and uncertainty data is not offered by the prior art, and is made possible by the numerical analysis technique employed in accordance with the invention to exploit the additional information attributable to the spectroscopic resolution of the collected spectrum.

At its broadest, while the method of the invention inherently exploits the spectroscopic resolution of the collected data to make an analysis of, and display, the uncertainty in the measure representative of collected data, the measurement and display of collected data itself need not be spectroscopically resolved. In the preferred case however, such incident radiation data is also processed spectroscopically, and presented resolved spectroscopically across a plurality of energy bands, for example in such case with an uncertainty measurement being presented for the overall spectrum and/or for the data in each band. Such spectroscopically resolved collected incident radiation data information could for example be used, as presented or by further numerical analysis, to give indications concerning identification of a source nuclide, for example to identify a particular target nuclide, to enable comparison between natural and artificial sources, to identify a particular artificial source or the like.

Preferably, the data processing step comprises a step performed repeatedly on progressively collected data as incident radiation data is collected at the detector over time, and the display step correspondingly presents in representative manner both the first and the second data items as they change as data is progressively collected over time.

Other preferred features of the method steps of the foregoing follow by analogy from the description of embodiments of the device and its operation.

It will be understood generally that a data processing step or a display step in the method of the above aspects of the invention can be implemented at least in part by a suitable set of machine readable instructions, data or code.

These machine readable instructions, data or code may be loaded onto a general purpose computer, special purpose computer, or other programmable data processing device to produce a means for implementing the step specified. These machine readable instructions, data or code may also be stored in a computer readable medium that can direct a computer or other programmable data processing device to function in a particular manner, such that the instructions stored in a computer readable medium produce an article of manufacture including instruction means to implement some or all of the numerical steps in the method of the invention.

Computer program instructions, data or code may be loaded onto a programmable device to produce a machine capable of implementing a computer executed process such that the instructions are executed on the programmable device providing steps for implementing some or all of the steps in the method of the above aspects of the invention. For example, computer program instructions, data or code may be loaded onto a programmable device to convert the programmable device into at least a data processing module and/or a display module in accordance with the foregoing or to perform at least the data processing and/or display steps in accordance with the foregoing. The suitable additional programmable device might for example be a portable computing device with a visual or other display capability such as a laptop, tablet, cell-phone etc., or a bespoke portable device.

In particular in accordance with a further aspect, the invention comprises a set of computer program instructions, for example provided on a suitable data carrier, which may be loaded onto a suitable programmable device so as when so loaded to cause the said programmable device to constitute at least a data processing module and/or a display module in accordance with the device aspects of the invention or to perform at least the data processing and/or display steps of the method aspects of the invention.

The computer program instructions may be provided in combination with a portable detector unit as above described which together convert the programmable device into a radiation detector device in accordance with the first aspect in the invention.

In accordance with a further aspect, the invention comprises a method of adapting an existing programmable device including a central processor to serve as a detector device in accordance with the first aspect in the invention.

In particular the method comprises the steps of:

connecting a portable detector unit comprising at least the detector and for example the detection module as above described into data communication to an additional programmable device including a central processor, and
providing suitable machine readable instructions to be implemented by the combination of the portable device and the additional programmable device so that the combination serves as a detection module, data processing module and a display module as above described in accordance with the first aspect in the invention.

The suitable additional programmable device might for example be a portable computing device with a visual or other display capability such as a laptop computer, a tablet computer, or similar portable computer; a cell-phone or like mobile communication device; or a bespoke portable device; into which the portable detector unit may be connected for data communication and transfer.

Other preferred features of the foregoing aspect follow by analogy from the description of embodiments of the device and its operation.

The invention in all aspects lies in particular in the use of spectroscopically resolved collected incident radiation data information as the basis not only for determination of a first data item being for example in the general sense an intensity measure such as a dose rate and for example an intensity spectrum such as a dose rate spectrum but also of a numerical calculation of a second data item being the statistical uncertainty in that determined intensity measurement, and in the display of this statistical uncertainty together with the display of the determined incident radiation measure.

The data processing step of the process thus includes, and the data processing module is thus adapted to perform, the steps necessary to derive at least the first and second data items numerically from the collected intensity data.

The data processing step of the process preferably includes, and the data processing module is thus preferably adapted to perform, a first step in which collected intensity data is processed numerically to derive data representative of a true spectrum, a further step in which the true spectrum is used to produce a cumulative intensity data spectrum such as a dose rate spectrum, and a further step in which the cumulative intensity data spectrum such as the dose rate spectrum rate spectrum is statistically analysed to produce an uncertainty measurement.

Any suitable numerical technique may be used to process collected intensity data to derive a true spectrum and/or a cumulative intensity data spectrum, for example including but not limited to deconvolution, Bayesian deconvolution, an iterative forward method for example using use a Chi-squared minimisation or a non-linear method.

Any suitable numerical technique may be used to produce an uncertainty measurement, for example including but not limited to the calculation of a Poisson error, a T-test analysis, a confidence limits analysis etc.

The display step of the process preferably includes the display of, and the display module is thus preferably adapted to display, at least a cumulative intensity data spectrum such as a dose rate spectrum and a measurement of uncertainty. Optionally the derived true spectrum may also be displayed and/or used for other purposes such as nuclide identification.

An example embodiment of operation in accordance with the principles of the invention including examples of information display will now be described by way of example only with reference to the accompanying drawings in which:

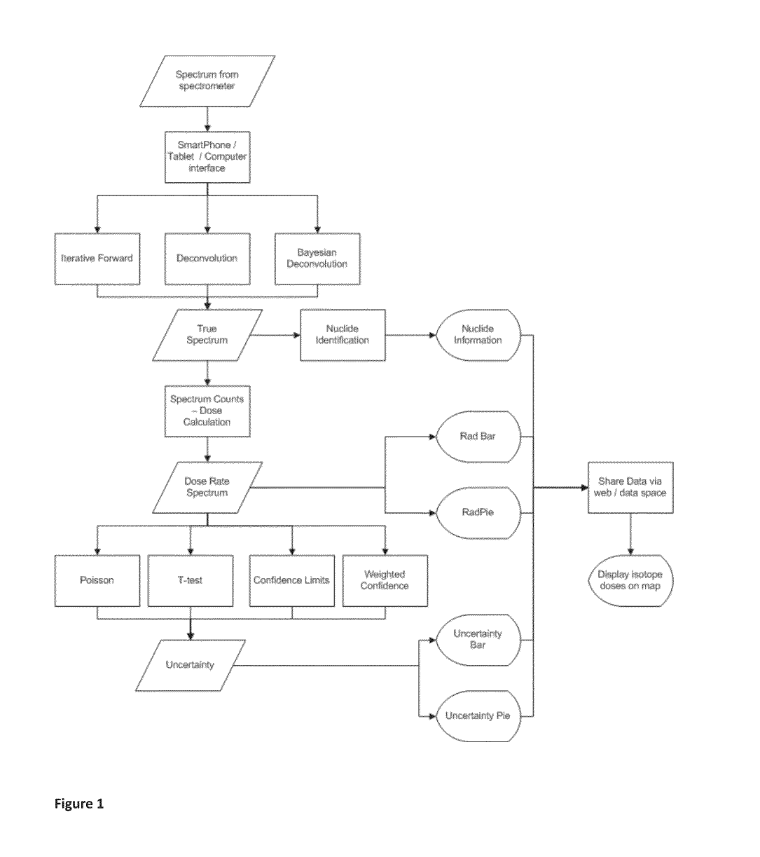

FIG. 1 is a process flow chart of a method of operation of an example system;

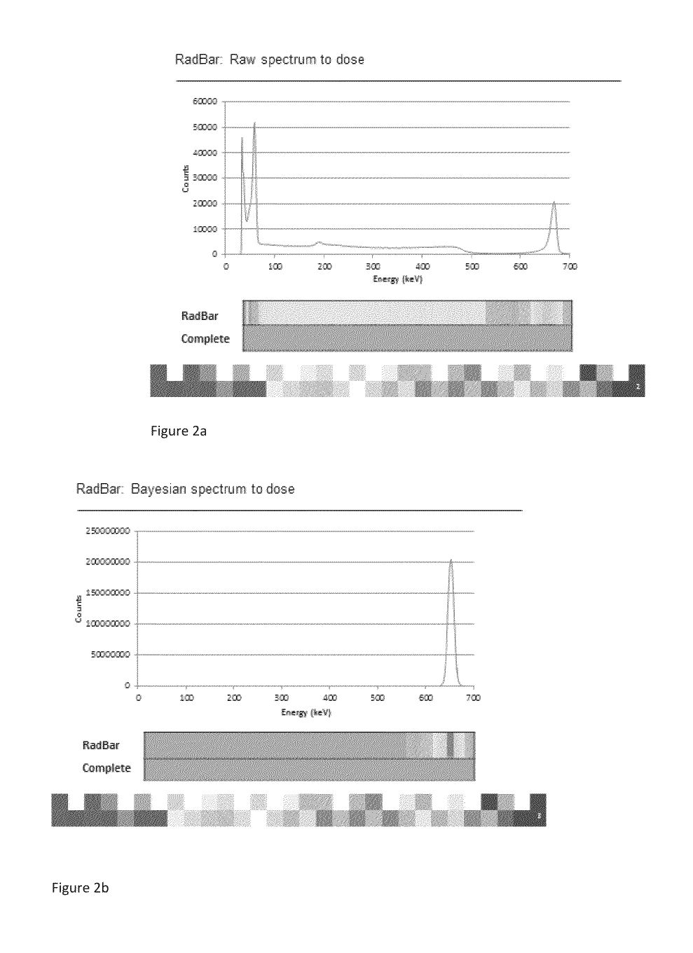

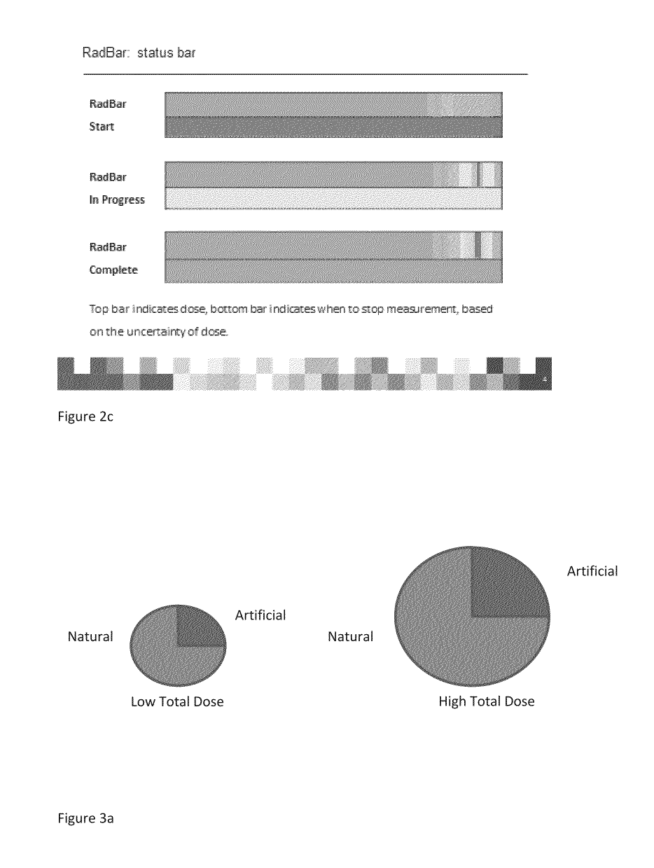

FIG. 2 shows some example information displays according to one possible display principle;

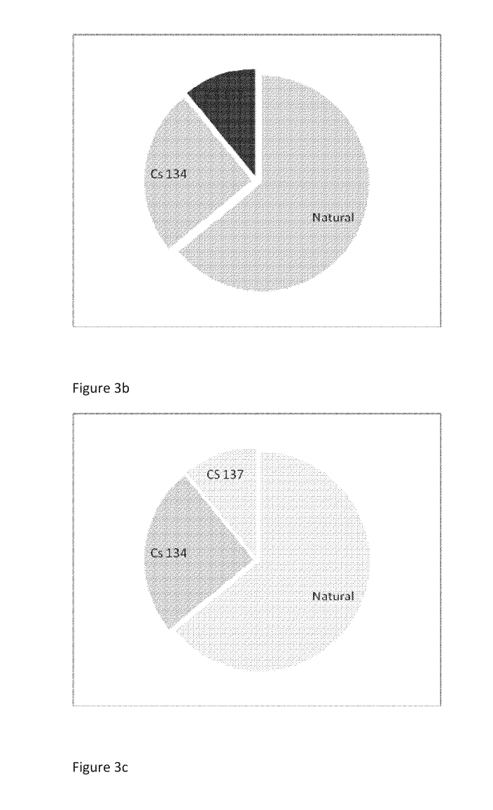

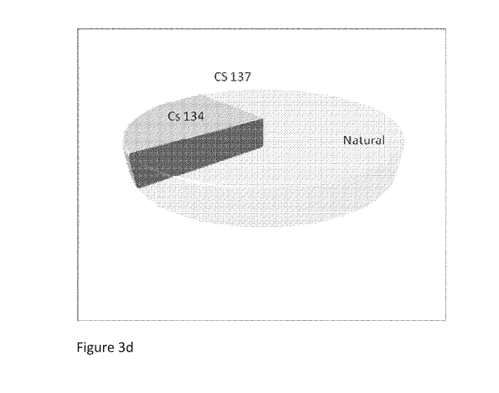

FIG. 3 shows some example information displays according to another possible display principle.

FIG. 1 shows a method of operation of an example system which takes count data from a portable spectrometer unit based and a cadmium telluride radiation detector into a device such as a smart phone, tablet or computer. This measured spectrum is then converted into a true spectrum of the radiation, which in turn is converted into dose rate measurements. Over time, as the counts collected increases the level of uncertainty in the dose falls, and this level of uncertainty is calculated and displayed to the user. The flow chart in FIG. 1 shows a suitable example process for this.

The key distinctive feature of the method can be seen in that the spectroscopic resolution in the collected radiation data is not only used to give nuclide information or to give a display of the cumulative dose with spectrum information. It is an advantage of using spectroscopically resolved data from a spectroscopically resolving detector such as cadmium telluride that this can be done.

However, the invention is characterised in that the spectroscopic resolution in the collected radiation data is also used in performing a statistical significance analysis of that data to give a quantitative measurement of the uncertainty which may be displayed alongside the dose rate spectrum.

The aim of the application is to present the information of the dose rate and uncertainty in a user-friendly manner. Several options for displaying the results of each measurement are described by way of example.

A first set of options is based on an elongate visual representation which has been called herein a RadBar in conjunction with a similar elongate visual representation of uncertainty which has been called herein an Uncertainty Bar or in the particular case where it is presented as an indication of status of progress of a data collection phase the Status Bar. Examples are shown in FIG. 2.

In the FIG. 2 examples the RadBar displays dose as a function of colour with the bar segmented into plural energy bins showing increasing energy. The Status Bar underneath the RadBar is presented to indicate when the measurement is starting, in progress or complete. This is determined by analysis of uncertainty on dose calculation.

Several options for the Uncertainty Bar are proposed. In the example in FIG. 2c the entire bar shows uncertainty in the total dose. The bar starts red, changes colour to green via amber as the uncertainty on the total dose decreases. The level of uncertainty which displays green may be pre-defined or user-settable.

In the alternative the Uncertainty Bar may be segmented into the same energy bins as the RadBar. The entire bar starts red as above, and each segment turns green as the uncertainty in the dose in the specific bin decreases.

The example in FIG. 2 shows a separate Uncertainty Bar alongside the RadBar. This is merely one alternative. In another alternative, the RadBar may display dose as a function of colour and simultaneously display uncertainty otherwise, for example as a function of saturation.

These are merely examples of the way in which a combined visual display may be adapted to use various visual modes to provide a representative quantification of each data item, for example including colour, brightness, saturation, pixellation, alphanumeric presentation and the like.

A further set of options for display is based on a sectored circular visual representation which has been called herein a RadPie. Examples are shown in FIG. 2. This may be useful where it is desirable to present in simple manner doses by type by proportion, for example when identifying by source, isotope etc.

A further possibility may be to use the measure of uncertainty as either a display criteria or data upload criteria for example onto a suitable website/data store etc. The user may choose only to display only dose rates with certainty above a level (either pre-defined or user-selectable) or alternatively the system may only allow data above a certain pre-defined certainty to be uploaded onto the website/data store.

Suggested Methods of presenting the data include:
a) Natural dose is coloured one colour, artificial (e.g. those identified as being from man made sources—reactor leak etc) another (see FIG. 3a). Proportions of each displayed by area, and the total dose given by the total size of the pie chart.
b) The total dose is again given by the size of the pie chart, but the colours represent the uncertainty in the measurement, for example starting from red as high uncertainty (see FIG. 3b).
c) The dose is given by colour, which starts faint and becomes stronger as the uncertainty decreases (see FIG. 3c).
d) A 3-d pie chart, where the total intensity is given by the height (see FIG. 3d). Uncertainty may be displayed by one of the above methods.
e) As above, but height increases as uncertainty decreases.

Alternatives to the above include each segment of the pie being a segment of the energy spectrum.

The data from a device can be uploaded to a website or other data space. This permits a map to be drawn showing the isotope dose levels. There may be a separate map for each isotope, or all isotopes may be plotted on the same map. Levels may be shown by spot size, or by bar heights, or by colour. Different isotopes on the same map may be differentiated by colour or marker type.

Currently, there are several different methods of processing which are being proposed both for the step of conversion to the true spectrum and for the uncertainty calculation. The precise method is not pertinent to the invention, Examples only follow.

Conversion from Measured Spectrum to True Spectrum
1) Iterative Forward method—Makes first estimate of real spectrum, computes the measured spectrum that this would give via the detector's response matrix. The difference between the computed measured spectrum and the actual measured spectrum is used to improve the estimate of the real spectrum. This iterative process may use a Chi-squared minimisation, or a non-linear method.
2) Simple Deconvolution—From the measured spectrum, use the inverse of the response matrix to calculate the real measured spectrum.
3) Bayesian Deconvolution—as with the Simple Deconvolution, but using Bayesian methods.

### Uncertainty Calculation

1) Poissson—may calculate the poisson error on the dose rate at each energy segment or identified segment.
2) T-test
3) Confidence Limits
4) Weighted confidence—each segment is weighted, maybe by the segment width, dose rate, number of energy peaks.

1. A radiation detector device comprising a detection module, a processing module, and a display module, wherein:
the detection module includes a detector adapted to detect incident radiation in spectroscopically resolved manner in plural separate energy bands;
the processing module is adapted to process the spectroscopically resolved data numerically and thereby to produce at least a first data item indicative of a measure of radiation incident at the detector and a second data item indicative of a statistical certainty applicable to the first data item; and
the display module is adapted to produce a display representative of both the first data item and the second data item.

2. The radiation detector device in accordance with claim 1, wherein the detector is adapted to differentiate incident radiation simultaneously into at least three energy bands across an expected detection spectrum.

3. The radiation detector device in accordance with claim 1, wherein the detector exhibits a spectroscopically variable response across at least a part of an expected detection spectrum allowing simultaneous differentiation of incident radiation into plural energy bands.

4. The radiation detector device in accordance with claim 1 wherein the data processing module is adapted to process the collected and spectroscopically resolved data in order to perform a statistical analysis of the quality of the data which produced the first data item relating to produce a second data item that comprises a quantified indication of the uncertainty in the first data item.

5. The radiation detector device in accordance with claim 1 wherein the display module is adapted to produce a display which includes a representation of a first data item corresponding to a measure of the radiation collected at the detector, and which further includes a second data item corresponding to a specific numerically calculated quantification of the uncertainty in that measurement of radiation.

6. The radiation detector device in accordance with claim 1 wherein the processing module is adapted to process the spectroscopically resolved data numerically and thereby to produce at least a first set of data items indicative of a radiation incident at the detector at a plurality of energy bands across at least a part of the detected spectrum, and the display module is adapted to produce a display representative of the first set of data items differentiated across the plurality of energy bands.

7. The radiation detector device in accordance with claim 1 wherein the data processing module is adapted to process the resolved incident radiation data set and obtain uncertainty information therefrom progressively as incident radiation data is collected at the detector, and the display is correspondingly adapted to display in representative manner both the first and the second data items as they change as data is progressively collected over time.

8. The radiation detector device in accordance with claim 1 wherein a calculated uncertainty is used as an indicator of progress of a data collection process.

9. The radiation detector device in accordance with claim 8, wherein the data processing module is programmed to include a definition of completion of a data collection phase defined as being determined by the calculated uncertainty falling below a pre-determined threshold value and the calculated uncertainty is used as an indicator of progress towards or completion of the data collection phase so defined.

10. The radiation detector device in accordance with claim 1, wherein the processing module is adapted to determine and the display module to display data indicating progress of data collection as a function of calculated uncertainty.

11. The radiation detector device in accordance with claim 1, wherein the display module is adapted to present on suitable display means a representative visual, audible or other quantification of each data item simultaneously or closely successively.

12. The radiation detector device in accordance with claim 1, wherein the display module is adapted to present differentiated data items in any combination of:
discrete representations displayed simultaneously via different sensory modalities;
discrete visual representations displayed simultaneously and spaced apart;
discrete representations displayed successively; and
a single representation providing a simultaneous quantification of multiple data items.

13. The radiation detector device in accordance with claim 1 wherein the first and second data items are displayed simultaneously.

14. The radiation detector device in accordance with claim 1, wherein the data processing module is adapted to perform a first step in which collected incident radiation data is processed numerically to derive data representative of a true spectrum, a further step in which the true spectrum is used to produce a cumulative intensity data spectrum comprising a dose rate spectrum, and a further step in which the cumulative intensity data spectrum comprising the dose rate spectrum rate spectrum is statistically analysed to produce an uncertainty measurement.

15. The radiation detector device in accordance with claim 14, wherein the data processing module is adapted to process collected incident radiation data to derive a true spectrum and/or a cumulative intensity data spectrum by a method selected from simple deconvolution, Bayesian deconvolution, an iterative forward method using use a Chi-squared minimisation or a non-linear method.

16. The radiation detector device in accordance with claim 14, wherein the data processing module is adapted to produce an uncertainty measurement by a method selected from calculation of a Poisson error, a T-test analysis, a confidence limits analysis.

17. The radiation detector device in accordance with claim 1 comprising a detector for high-energy radiation selected from one or more of:
high energy electromagnetic radiation comprising at least one of x-rays and gamma rays, and subatomic particle radiation.

18. The radiation detector device in accordance with claim 1, wherein the detector exhibits a spectroscopically variable response across at least a part of an expected radiation spectrum allowing spectroscopic information to be retrieved and allowing incident radiation information to be detected simultaneously at a plurality of differentiated energy bands.

19. The radiation detector device in accordance with claim 18, wherein the detector comprises one or more detector elements of a semiconductor material adapted for high energy physics applications, and wherein the semiconductor material of at least one of the detector elements is a material adapted to exhibit a spectroscopically variable response across at least a substantial part of the intended radiation spectrum in use.

20. The radiation detector device in accordance with claim 19, wherein the semiconductor material is selected from cadmium telluride, cadmium zinc telluride (CZT), cadmium manganese telluride (CMT), and alloys thereof, and save for incidental impurities, consists essentially of crystalline Cd_{1-(a+b)}MnₐZn_{b}Te where a+b<1 and a and/or b may be zero.

21. The radiation detector device comprising a portable detector unit including a detector comprising one or more detector elements within a housing in association with such further components and control electronics as may be necessary to enable the collection and downloading to a suitable processing module of spectroscopically resolved data regarding incident radiation; in data communication with a data processing module and display module so as to constitute a radiation detector device in accordance with claim 1.

22. The radiation detector device in accordance with claim 21, wherein the data processing module and display module are constituted by a further discrete device including a central processor with which the detector is provided for use with and is functionally connected to in use.

23. The radiation detector device in accordance with claim 22, wherein the further device comprises a programmable device provided with suitable device readable instructions so as to constitute in combination with the portable detector unit a detection module and a data processing module and a display module.

24. The radiation detector device in accordance with claim 22, wherein the further device is a portable computing device with a visual or other display capability.

25. The radiation detector device in accordance with claim 24, wherein the further device is selected from:
a laptop computer, a tablet computer, a cell-phone or like mobile communication device.

26. The radiation detector device comprising in combination:
a portable detector unit comprising at least the detector and the detection module and including a data communication means to effect a data communication to an additional programmable device including a central processor, and
suitable machine readable instructions to be implemented by the combination of the portable device and the additional programmable device when connected in data connection so that the combination serves as a detection module, data processing module and a display module in accordance with claim 1.

27. The radiation detector device in accordance with claim 26, wherein the additional programmable device when so programmed with the suitable machine readable instructions serves as a data processing module and a display module.

28. A kit of parts adapted for use with a suitable programmable device including a central processor so as to convert the programmable device into a radiation detector device in accordance with claim 1 comprising:
a portable detector unit comprising at least the detector and including a data communication means to effect a data communication to the programmable device, and
suitable machine readable instructions to be implemented by the combination of the portable detector unit and the programmable device when connected in data connection so that the combination when so connected and programmed constitutes a detection module, data processing module and a display module.

29. The use of a radiation detector device in accordance with claim 1 to collect incident radiation data in spectroscopically resolved manner resolved into plural separate energy bands, and to calculate and display therefrom at least a first data item indicative of a measure of radiation incident at the detector and a second data item indicative of a statistical certainty applicable to the first data item.

30. A method for the processing for display and preferably further for the display of detected radiation data which has been spectroscopically into plural separate energy bands, comprising the steps of:
processing the spectroscopically resolved data numerically to produce at least a first data item indicative of a measure of radiation incident at the detector and a second data item indicative of a statistical certainty applicable to the first data item; and
optionally further presenting a display representative of both the first data item and the second data item.

31. The method for the detection of radiation comprising the method of claim 30 and further comprising, prior to the performance of the foregoing steps, a step of:
collecting incident radiation at a detector in such manner that the incident radiation is spectroscopically resolved into plural separate energy bands by bringing a suitable radiation detector device into an environment to be tested and collecting incident radiation at the detector for a suitable time period.

32. The method in accordance with claim 30, wherein the incident radiation is spectroscopically resolved simultaneously into at least three energy bands across an expected detection spectrum.

33. The method in accordance with claim 30, wherein the step of processing the resolved data comprises performing a statistical analysis of the quality of the data which produced the first data item relating to produce a second data item that comprises a quantified indication of the uncertainty in the first data item.

34. The method in accordance with claim 30, wherein the step of presenting a display comprises presenting a display which includes a representation of a first data item corresponding to a measure of the radiation collected at the detector, and which further includes a second data item corresponding to a specific numerically calculated quantification of the uncertainty in that measurement of intensity.

35. The method in accordance with claim 30, wherein the data processing step comprises producing at least a first set of data items indicative of a measure of radiation incident at the detector at a plurality of energy bands across at least a part of the detected spectrum, and the display step comprises presenting a display representative of the first set of data items differentiated across the plurality of energy bands.

36. The method in accordance with claim 30, wherein the data processing step comprises a step performed repeatedly on progressively collected data as intensity data is collected at the detector over time, and the display step correspondingly comprises presenting a display representative of both the first and the second data items as they change as data is progressively collected over time.

37. The method in accordance with claim 30, wherein a calculated uncertainty is used as an indicator of progress of a data collection process.

38. The method in accordance with claim 30, wherein a completion of a data collection phase is defined as being determined by the calculated uncertainty falling below a pre-determined threshold value and the calculated uncertainty is used as an indicator of progress towards or completion of the data collection phase so defined.

39. The method in accordance with claim 30, wherein the display step comprises presenting a display indicating progress of data collection as a function of calculated uncertainty.

40. The method in accordance with claim 30, wherein the display step comprises presenting a representative visual, audible or other quantification of each data item simultaneously or closely successively.

41. The method in accordance with claim 30, wherein the display step comprises presenting differentiated data items in any combination of:
discrete representations displayed simultaneously via different sensory modalities;
discrete visual representations displayed simultaneously and spaced apart;
discrete representations displayed successively; and
a single representation providing a simultaneous quantification of multiple data items.

42. The method in accordance with claim 30, wherein the first and second data items are displayed simultaneously.

43. The method in accordance with claim 30, wherein the data processing step includes a first step in which collected incident radiation data is processed numerically to derive data representative of a true spectrum, a further step in which the true spectrum is used to produce a cumulative intensity data spectrum comprising a dose rate spectrum, and a further step in which the cumulative intensity data spectrum comprising the dose rate spectrum rate spectrum is statistically analysed to produce an uncertainty measurement.

44. The method in accordance with claim 43, wherein the step of deriving a true spectrum and/or a cumulative intensity data spectrum comprises a step selected from:
simple deconvolution, Bayesian deconvolution, an iterative forward method using use a Chi-squared minimisation or a non-linear method.

45. The method in accordance with claim 43, wherein the step of deriving an uncertainty measurement comprises a step selected from:
the calculation of a Poisson error, a T-test analysis, a confidence limits analysis.

46. The method in accordance with claim 43, wherein the display step includes the display of at least a cumulative intensity data spectrum comprising a dose rate spectrum and a measurement of uncertainty.

47. A set of computer program instructions loadable onto a suitable programmable device so as when so loaded to cause the said programmable device to constitute at least one of a data processing module and a display module in accordance with the device of claim 1 or to perform at least the data processing and/or display steps of:
processing spectrally resolved data numerically to produce at least a first data item indicative of a measure of radiation incident at the detector and a second data item indicative of a statistical certainty applicable to the first data item; and
optionally further presenting a display representative of both the first data item and the second data item.

48. A machine readable data carrier comprising a set of computer program instructions in accordance with claim 47.

49. A set of computer program instructions in accordance with claim 47 provided in combination with a portable detector unit including a detector comprising one or more detector elements within a housing in association with such further components and control electronics as may be necessary to enable collection and downloading to a suitable processing module of spectroscopically resolved data regarding incident radiation; which together are adapted in use to convert an additional programmable device including a central processor to serve as a radiation detector device comprising a detection module, a processing module, and a display module, wherein:
the detection module includes a detector adapted to detect incident radiation in spectroscopically resolved manner in plural separate energy bands;
the processing module is adapted to process the spectroscopically resolved data numerically and thereby to produce at least a first data item indicative of a measure of radiation incident at the detector and a second data item indicative of a statistical certainty applicable to the first data item; and
the display module is adapted to produce a display representative of both the first data item and the second data item.

50. The combination of claim 49 provided further in combination with the additional programmable device.

51. The combination of claim 50, wherein the additional programmable device is a portable computing device with a visual or other display capability.

52. The combination of claim 51, wherein the additional programmable device is selected from:
a laptop computer, a tablet computer, a cell-phone or like mobile communication device.

53. A method of adapting an existing programmable device including a central processor to serve as a detector device in accordance with the first aspect in the invention comprising the steps of:
connecting a portable detector unit including a detector comprising one or more detector elements within a housing in association with such further components and control electronics as may be necessary to enable the collection and downloading to a suitable processing module of spectroscopically resolved data regarding incident radiation into data communication to an additional programmable device including a central processor, and
providing suitable machine readable instructions to be implemented by the combination of the portable device and the additional programmable device so that the combination serves as a detection module, data processing module and a display module in accordance with claim 1.

54. The method of claim 53, wherein the additional programmable device is a portable computing device with a visual or other display capability.

55. The method of claim 54, wherein the additional programmable device is selected from:
a laptop computer, a tablet computer, a cell-phone or like mobile communication device.
